(19) United States
(12) Patent Application Publication
(10) Pub. No.: US 2009/0284125 A1
(43) Pub. Date: Nov. 19, 2009

(54) Plasma display panel and method of forming the same

(76) Inventors: Seong-chan BAE, Suwon-si (KR); Chun-Gyoo LEE, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/453,544

(22) Filed: May 14, 2009

(30) Foreign Application Priority Data
May 15, 2008 (KR) 10-2008-0045091

(51) Int. Cl. H01J 63/04; H01J 9/00

(52) U.S. Cl. 313/485; 445/24

(57) ABSTRACT

A plasma display panel includes first and second substrates facing each other and spaced apart from each other, barrier ribs arranged between the first and second substrates to define discharge cells, phosphor layers in the discharge cells, address electrodes extending on the first substrate along a first direction to correspond to the discharge cells, first and second electrodes extending on the second substrate along a second direction to correspond to the discharge cells, the second direction crossing the first direction, a dielectric layer on the first and second electrodes, and a doped protective layer on the dielectric layer, the protective layer including at least one groove.

### BACKGROUND OF THE INVENTION

1. Field of the Invention

Exemplary embodiments relate to a plasma display panel (PDP) and method of forming the same. More particularly, exemplary embodiments relate to a PDP with a protective layer and method of forming the same.

2. Description of the Related Art

Generally, a PDP refers to a display device that excites phosphors with vacuum ultraviolet (VUV) rays radiated from plasma obtained through gas discharge, and displays desired images by using visible light of red (R), green (G), and blue (B) colors generated as the phosphors become stable.

For example, the conventional PDP may include electrodes between two substrates, so application of voltage to the electrodes may trigger discharge in the discharge gas, i.e., He gas, Ne gas, and/or Xe gas, and VUV emission. The conventional PDP may further include a protective layer on the electrodes to protect the electrodes from charged particles, i.e., ions, electrons, and neutrons generated during the discharge.

The conventional protective layer may also emit secondary electrons when contacted by the charged particles. As a secondary electron emission coefficient of the protective layer increases, discharge firing voltage of the PDP may decrease.

The above information disclosed in this Background section is only for enhancement of understanding of the background of the invention and therefore it may contain information that does not form the prior art that is already known in this country to a person of ordinary skill in the art.

### SUMMARY OF THE INVENTION

Exemplary embodiments are therefore directed to a PDP with a doped protective layer and a method of forming the same, which substantially overcomes one or more of the shortcomings and disadvantages of the related art.

It is therefore a feature of an exemplary embodiment to provide a PDP with a doped protective layer having a structure capable of intercepting a loss path of the wall charges, thereby improving discharge characteristics and increasing operation margin.

It is another feature of an exemplary embodiment to provide a method of forming a PDP with a doped protective layer having a structure capable of intercepting a loss path of the wall charges, thereby improving discharge characteristics and increasing operation margin.

At least one of the above and other features may be realized by providing a PDP, including first and second substrates facing each other and spaced apart from each other, barrier ribs arranged between the first and second substrates to define discharge cells, phosphor layers in the discharge cells, address electrodes extending on the first substrate along a first direction to correspond to the discharge cells, first and second electrodes extending on the second substrate along a second direction to correspond to the discharge cells, the second direction crossing the first direction, a dielectric layer on the first and second electrodes, and a doped protective layer on the dielectric layer, the doped protective layer including at least one groove.

The doped protective layer may include a dopant, the dopant being one or more of Si, Al, Be, Cr, V, Sr, Ca, Li, F, Fe, Zr, Ni, and Sc.

The groove may extend through an entire thickness of the protective layer and into a portion of the dielectric layer.

The PDP may include a residue portion formed around the groove by the laser machining.

The residue portion may be formed of MgO of the protective layer and a dielectric material of the dielectric layer. The residue portion may have non uniform height and uneven surface, the height and surface being determined with respect to a substantially flat interface between the doped protective layer and the dielectric layer The groove may include at least one first groove extending in the second direction while crossing centers of the discharge cells.

Each of the first electrodes and the second electrodes may include at least one bus electrode extending in the second direction at edge portions of the discharge cells in the first direction, and at least one transparent electrode expanding to an inside of the discharge cells. The groove may include at least one second groove corresponding to at least one of the bus electrodes of the discharge cells and parallel to the first groove.

One bus electrode of the first electrode and one bus electrode of the second electrode may correspond to each discharge cell, and a pair of second grooves may correspond to the bus electrodes of the first and second electrodes at each discharge cell.

The barrier ribs may include first barrier rib members extending in the first direction and second barrier rib members extending in the second direction to cross the first barrier rib members. The groove may further include at least one third groove extending in the first direction and corresponding to the first barrier rib members.

The groove may define two spaces at each discharge cell and the two spaces may be adjacent to each other in the first direction.

The groove may define two spaces at each discharge cell and the two spaces may be adjacent to each other in the first direction, and may define a boundary of each discharge cell along the second direction.

The groove may define two spaces at each discharge cell and the two spaces may be adjacent to each other in the first direction, and may define each discharge cell along the first direction and in the second direction.

The PDP may include a plurality of grooves facing the discharge cells, each groove extending along the second direction to overlap a plurality of discharge cells, at least one groove corresponding to each discharge cell.

At least one of the above and other features may be realized by providing a method of forming a PDP, including forming first and second substrates facing each other and spaced apart from each other, forming barrier ribs between the first and second substrates to define discharge cells, forming phosphor layers in the discharge cells, forming address electrodes extending on the first substrate along a first direction to correspond to the discharge cells, forming first and second electrodes extending on the second substrate along a second direction to correspond to the discharge cells, the second direction crossing the first direction, forming a dielectric layer on the first and second electrodes, and forming a doped protective layer on the dielectric layer, the doped protective layer including at least one groove formed by laser machining.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a PDP according to an exemplary embodiment;

FIG. 2 illustrates a cross-sectional view along line II-II of FIG. 1;

FIG. 3 illustrates a top plan view of an arrangement of discharge cells, electrodes, and grooves of FIG. 1;

FIG. 4 illustrates a detailed cross-sectional view of the groove in FIG. 1.

FIG. 5 illustrates a photograph of a top plan of grooves;

FIG. 6 illustrates an enlarged photograph of a top plan of the grooves;

FIG. 7 illustrates a photograph of a cross-section of the groove;

FIG. 8 illustrates a view of a shape change of the protective layer portion surrounding the groove;

FIG. 9 illustrates a top plan view of an arrangement of discharge cells, electrodes, and grooves according to another exemplary embodiment; and

FIG. 10 illustrates a top plan view of an arrangement of discharge cells, electrodes, and grooves according to another exemplary embodiment.

### DETAILED DESCRIPTION OF THE INVENTION

Korean Patent Application No. 10-2008-0045091, filed on May 15, 2008, in the Korean Intellectual Property Office, and entitled: “Plasma Display Panel,” is incorporated by reference herein in its entirety.

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together.

As used herein, the terms “a” and “an” are open terms that may be used in conjunction with singular items or with plural items.

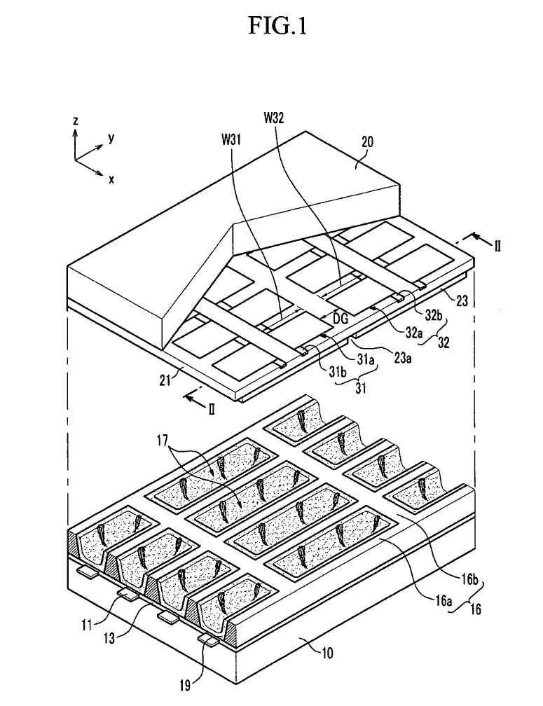

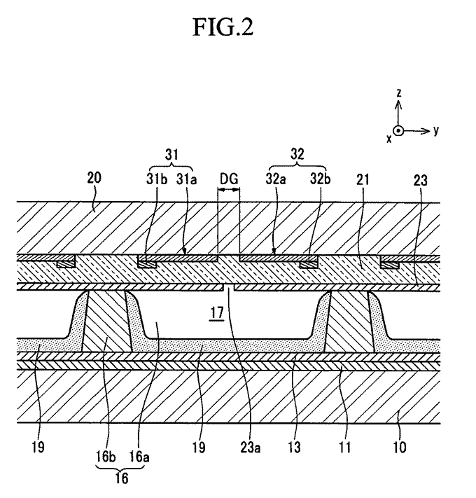

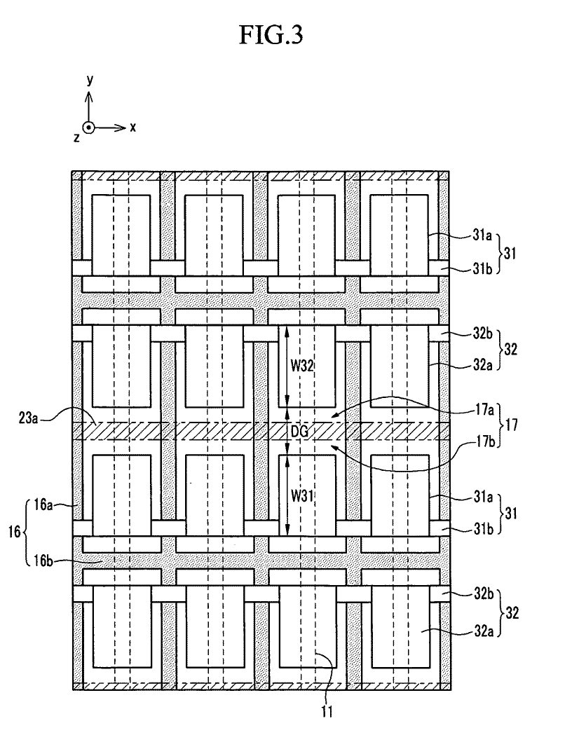

FIG. 1 illustrates an exploded perspective view of a PDP according to an exemplary embodiment, FIG. 2 illustrates a cross-sectional view along line II-II of FIG. 1, and FIG. 3 illustrates a top plan view of an arrangement of discharge cells, electrodes, and grooves in FIG. 1.

Referring to FIGS. 1-3, a PDP, e.g., an alternating current (AC) type PDP, may include a first substrate 10, e.g., a rear substrate, a second substrate 20, e.g., a front substrate, facing the first substrate 10 with a predetermined interval therebetween, and barrier ribs 16 disposed in the interval between the first substrate 10 and the second substrate 20 to define a plurality of discharge cells 17. The discharge cells 17 may be filled with a discharge gas, e.g., a gas mixture of xenon (Xe) and neon (Ne), for generating a plasma discharge by using gas discharge.

The PDP may further include address electrodes 11, first electrodes 31, e.g., sustain electrodes, and second electrodes 32, e.g., scan electrodes, between the first substrate 10 and the second substrate 20. The address electrodes 11, first electrodes 31, and second electrodes 32 may be interposed to correspond to each discharge cell 17 in order to generate the gas discharge therein.

For example, the address electrodes 11 may extend in a first direction, e.g., along the y-axis, on an inner surface of the first substrate 10, i.e., a surface facing the second substrate 20, such that each address electrode 11 may correspond to an array of discharge cells 17 arranged adjacently to each other in the first direction. The address electrodes 11 may be parallel to each other and spaced apart from each other along a second direction, e.g., along the x-axis, such that two adjacent address electrodes 11 may correspond to two discharge cells 17 adjacent to each other along the second direction. Since the address electrodes 11 are disposed on the first substrate 10, visible light may be transmitted through the second substrate 20. Thus, the address electrodes 11 may be formed as opaque electrodes. As an example, the address electrodes 11 may be formed as metal electrodes having excellent electrical conductivity.

The PDP may further include a first dielectric layer 13 to cover the inner surface of first substrate 10 and the address electrodes 11. The first dielectric layer 13 may prevent positive ions or electrons from directly colliding with the address electrodes 11 when the discharge is generated, and thus, may prevent damage to the address electrodes 11. The first dielectric layer 13 may form and accumulates wall charges.

The barrier ribs 16 may be provided on the first dielectric layer 13 to define the discharge cells 17. The barrier ribs 16 may include first barrier rib members 16a extending in the first direction, e.g., along the y-axis, and second barrier rib members 16b disposed between the first barrier rib members 16a and extending in the second direction, e.g., along the x-axis. For example, as illustrated in FIG. 1, the first barrier rib members 16a and the second barrier rib members 16b may form the discharge cells 17 in a matrix structure, e.g., millions or more of the discharge cells 17 may be arranged in a matrix structure in the PDP. In another example, the barrier ribs 16 may be formed by only first barrier rib members extending in the first direction, i.e., without second barrier rib members, to form discharge cells in a stripe structure, i.e., to have an open structure along the y-axis.

Phosphor layers 19 formed in the discharge cells 17 may absorb VUV rays and generate visible light. For example, a phosphor paste may be coated on a side surface of the barrier ribs 16 and on a surface of the first dielectric layer 13 surrounded by the barrier ribs 16, followed by drying and baking the coated phosphor paste to form the phosphor layers 19 in the discharge cells 17. The phosphor layers 19 may be formed to have phosphors generating a same color visible light in discharge cells 17 arranged in the first direction, e.g., along the y-axis. The phosphor layers 19 may be formed to have phosphors generating red R, green G, and blue B visible light repeatedly arranged in discharge cells 17 disposed in the second direction, e.g., along the x-axis.

Display electrodes, i.e., the first electrodes 31 and the second electrodes 32, may be formed on the inner surface of the second substrate 20, i.e., a surface facing the first substrate 10, and may form a surface discharge structure in order to generate gas discharge in each of the discharge cells 17. The first electrodes 31 and the second electrodes 32 may extend in the second direction, e.g., along the x-axis, to cross the address electrode 11. The first electrodes 31 and the second electrodes 32 may respectively include transparent electrodes 31a and 32a that generate discharge, and bus electrodes 31b and 32b that respectively apply a voltage signal to the transparent electrodes 31a and 32a.

Since the transparent electrodes 31a and 32a may be disposed inside the discharge cells 17 to generate the surface discharge, the transparent electrodes 31a and 32a may be made of a transparent material, e.g., indium tin oxide (ITO), to provide an improved aperture ratio of the discharge cells 17. The bus electrodes 31b and 32b may be made of a metal material having excellent electrical conductivity to compensate for a high electrical resistance of the transparent electrodes 31a and 32a.

That is, as illustrated in FIGS. 1-2, the bus electrodes 31b and 32b may be formed at the edge portions of the discharge cells 17, i.e., edges extending along the x-axis, and the transparent electrodes 31a and 32a may extend from respective bus electrodes 31b and 32b toward the centers of the discharge cells 17 in the y-axis direction. The transparent electrodes 31a and 32a may have widths W31 and W32, respectively, as illustrated in FIGS. 1 and 3. Thus, as illustrated in FIG. 3, the transparent electrodes 31a and 32a may extend toward each other above a discharge cell 17 to define a surface discharge structure, such that a discharge gap DG may be formed between the transparent electrodes 31a and 32a. The discharge gap DG may correspond to a center portion of the discharge cells 17.

The bus electrodes 31b and 32b may extend in the x-axis direction along the edge portions of the discharge cells 17 to be respectively disposed on the transparent electrodes 31a and 32a. Accordingly, voltage signals applied to the bus electrodes 31b and 32b may be respectively applied to the transparent electrodes 31a and 32a that may be respectively connected to the bus electrodes 31b and 32b.

A second dielectric layer 21, as illustrated in FIG. 2, may cover the inner surface of the second substrate 20, the first electrodes 31, and the second electrodes 32. When a gas discharge is generated in the discharge cells 17, the second dielectric layer 21 may protect the first electrodes 31 and the second electrodes 32 from the gas discharge, and may form and accumulate wall charges when the gas discharge is generated.

A protective layer 23 may cover the second dielectric layer 21, as illustrated in FIG. 2. For example, the protective layer 23 may be formed on the second dielectric layer 21, i.e., between the second dielectric layer 21 and the discharge cells 17. Accordingly, the protective layer 23 may protect the second dielectric layer 21 during the gas discharge, and may increase an amount of emitted secondary electrons when the discharge is generated, i.e., according to a secondary electron emission coefficient.

As an example, when driving the PDP, a reset discharge may be generated by a reset pulse applied to the second electrodes 32 in a reset period. In a scan period following the reset period, an address discharge may be generated by a scan pulse applied to the second electrodes 32 and an address pulse may be applied to the address electrodes 11. Then, in a sustain period, a sustain discharge may be generated by a sustain pulse that may be alternately applied to the first and second electrodes 31 and 32.

The first and second electrodes 31 and 32 may function as electrodes for applying the sustain pulse required for the sustain discharge. The second electrodes 32 may function as electrodes for applying the reset and scan pulses. The address electrodes 11 may function to apply the address pulse. The first electrodes, second electrodes, and address electrodes 31, 32, and 11 may vary their functions depending on voltage waveforms respectively applied thereto. Therefore, the functions may not be limited to the above-described case. The PDP may select discharge cells 17 that will be turned on by the address discharge occurring by the interaction between the address and second electrodes 11 and 32, and may drive the selected discharge cells 17 using the sustain discharge occurring by the interaction between the first and second electrodes 31 and 32, thereby displaying an image.

The PDP according to exemplary embodiments may increase the operation margin thereof, as well as improve its the discharge characteristics, by using a doped protective layer 23 and at least one groove 23a therein.

For example, particles contacting the protective layer 23 may be adhered to the protective layer 23, so the adhered charged particles may be neutralized by electrons at a valence band of the protective layer 23. Therefore, an energy difference between the adhered charged particles and the valence electrons of the protective layer 23 may cause emission of other electrons of the protective layer to the air.

Accordingly, emission of the secondary electrons in the PDP may be mainly triggered by Ne ions and He ions, since the Ne and He ions have a relatively high ionization energy of about 21.6 eV and about 24.6 eV, respectively. In other words, few secondary electron emission may be generated by Xe ions because Xe ions have relatively low ionization energy.

Thus, in the present invention, attempts have been made to increase secondary electron emission generated by Xe ions. For example, the protective layer 23 may be doped to increase generation of secondary electron emission by Xe ions. Since surface conductivity of a doped protective layer 23 may be higher than a non-doped protective layer, thereby increasing loss of wall charges and reducing operation margin thereof. Thus, in the present invention, the at least one groove 23a is formed in the protective layer 23 in order to reduce the surface conductivity.

For example, the protective layer 23 may include doped magnesium oxide (MgO) to provide high secondary electron emission coefficient and low sputtering rate to improve discharge characteristics of the PDP. The dopant in the protective layer 23 may include one or more of Si, Al, Be, Cr, V, Sr, Ca, Li, F, Fe, Zr, Ni, and Sc. The dopant may be mixed with a deposition source, e.g., MgO, in a state of an oxide or a nitride. Then, the dopant and the material of the deposition source may be deposited on the second dielectric layer 21 to form the protective layer 23. The dopant in the protective layer 23 may increase secondary electron emission from the protective layer 23, so the doped protective layer 23 may have a high secondary electron emission coefficient. A concentration of the dopant in the protective layer 23, e.g., MgO layer, may be about 10 ppm to about 1,000 ppm.

As illustrated in FIGS. 1-3, at least one groove 23a may be formed in the protective layer 23, e.g., by laser machining, to face the discharge cells 17 in order to partially reduce surface conductivity of the protective layer 23, so loss of wall charges from the protective layer 23 may be reduced or substantially minimized. For example, as illustrated in FIG. 3, the at least one groove 23a may extend along the second direction, e.g., along the x-axis. As further illustrated in FIG. 3, the at least one groove 23a may have any suitable shape and configuration, e.g., the at least one groove 23a may have a linear structure extending, e.g., continuously, along an entire display area to overlap a plurality of discharge cells 17. As illustrated in FIGS. 1-3, the discharge gap DG may overlap, e.g., completely overlap, the at least one groove 23a, so the at least one groove 23a may cross a plurality of discharge cells 17 along centers thereof. As illustrated in FIG. 2, the discharge gap DG may be wider along the y-axis than the groove 23a.

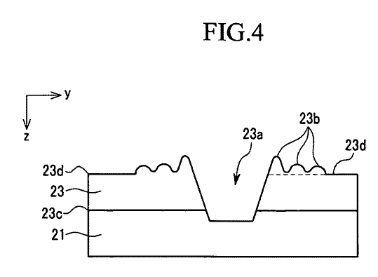

In particular, since a doped protective layer may have a high secondary electron emission coefficient and high surface conductivity, as compared with a non-doped layer, e.g., non-doped MgO layer, the groove 23a may reduce the surface conductivity of the protective layer 23 by intercepting the protective layer 23, i.e., a path of charges, thereby preventing the loss of wall charges through the path. Accordingly, formation of a doped protective layer 23 with at least one groove 23a according to exemplary embodiments may increase the secondary electron emission coefficient of the protective layer 23 and may reduce the surface conductivity of the protective layer 23. Hereinafter, the groove 23a for preventing the loss of the wall charges and reducing the surface conductivity of the protective layer 23 will be described in more detail with reference to FIG. 4.

FIG. 4 illustrates an enlarged, detailed cross-sectional view of the at least one groove 23a. Referring to FIG. 4, the groove 23a may be formed in the protective layer 23, and may extend through an entire depth of the protective layer 23, i.e., along the z-axis. As illustrated in FIG. 4, the protective layer 23 may have a first surface 23c, i.e., a substantially flat interface between the protective layer 23 and the second dielectric layer 21, and a second surface 23d, i.e., a substantially flat surface parallel and opposite the first surfaces 23c. The groove 23a may extend through the protective layer 23 into a portion of the dielectric layer 21, such that a depth of the groove 23a along a third direction, e.g., along the z-axis, may be larger than a thickness of the protective layer 23 along the third direction. That is, as illustrated in FIGS. 2 and 4, a distance along the third direction between a bottom of the groove 23a, i.e., a surface defining an interface between the groove 23a and the second dielectric layer 21 and being substantially parallel to the first surface 23c, and the second substrate 20 may be smaller than a distance along the third direction between the first surface 23a and second substrate 20. Since the groove 23a may be formed by laser machining, the precision of the laser machining may be used to adjust the depth of the groove 23a, e.g., a depth of the groove 23a inside the second dielectric layer 21.

As further illustrated in FIG. 4, the protective layer 23 may include a residue portion 23b adjacent to the groove 23a. More specifically, since the groove 23a may be formed by laser machining, the process of laser machining may cause formation of the residue portion 23b on a portion of the protective layer 23 around the groove 23a. For example, the residue portion 23b may be formed on the second surface 23d of the protective layer 23 and may surround, e.g., completely surround, the groove 23a. Since the groove 23a may be formed by laser machining, the residue portion 23b may include material removed from the protective layer 23 to form the groove 23a, e.g., the residue portion 23b may include MgO with a dopant. When a portion of the groove 23a is formed in the second dielectric layer 21, the residue portion 23b may further include a dielectric material of the second dielectric layer 21 in addition to the material of the protective layer 23, thereby reducing surface conductivity of the protective layer 23. A height of the residue portion 23b along the third direction, i.e., as measured from the second surface 23d, may decrease as a distance from the groove 23a along the second direction increases. Further, a surface of the residue portion 23b, i.e., a surface facing away from the second surface 23d, may be uneven. Therefore, the surface structure of the residue portion 23b, i.e., non-uniform height and uneven surface, may increase surface roughness around the groove 23a, so interception of charge path may be facilitated by the groove 23a, thereby reducing surface conductivity of the protective layer 23.

The PDP may include a plurality of grooves 23a in the protective layer 23. The plurality of grooves 23a may be arranged in any suitable configuration, e.g., along each row of discharge cells 17, along alternating rows of discharge cells 17, and so forth. FIG. 5 illustrates a photograph of a top plan of a plurality of grooves 23a arranged along each row of discharge cells.

For example, referring to FIG. 5, the grooves 23a may extend in the x-axis direction, and may be spaced apart from each other by a distance corresponding to the discharge cells 17 in the y-axis direction. Referring to FIGS. 1-3, the grooves 23a may extend in the x-axis direction while crossing centers of the discharge cells 17. Since the groove 23a may be narrower than the discharge gap DG and centered along the discharge gap DG, as illustrated in FIG. 2, the groove 23a may define two sections of the protective layer 23 in each discharge cell 17. In other words, the groove 23a may separate each discharge cell 17 into two spaces adjacent to each other along the y-axis. The two spaces defined by the groove 23a, i.e., first and second spaces 17a and 17b illustrated in FIG. 3, may be arranged along the y-axis to face each other with the groove 23a and discharge gap DG therebetween. Accordingly, since the groove 23a may be in a center of each discharge cell 17, the loss of wall charges generated in the y-axis direction within the discharge cell 17 may be prevented or substantially minimized by the groove 23a.

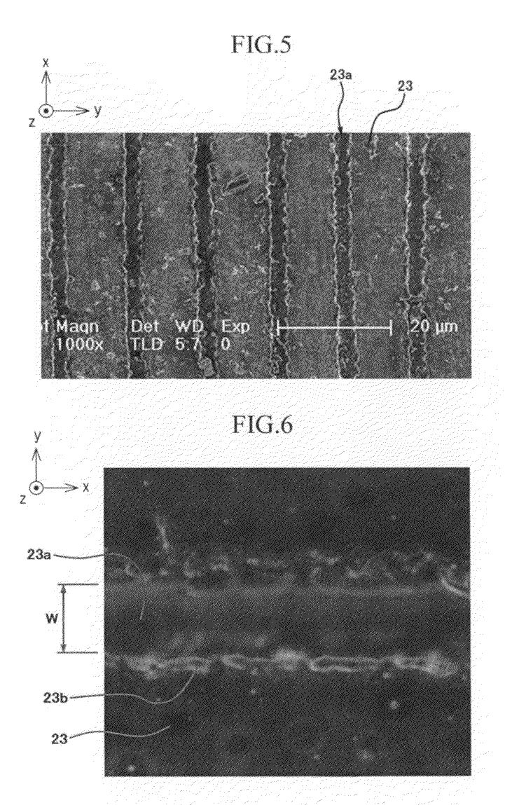

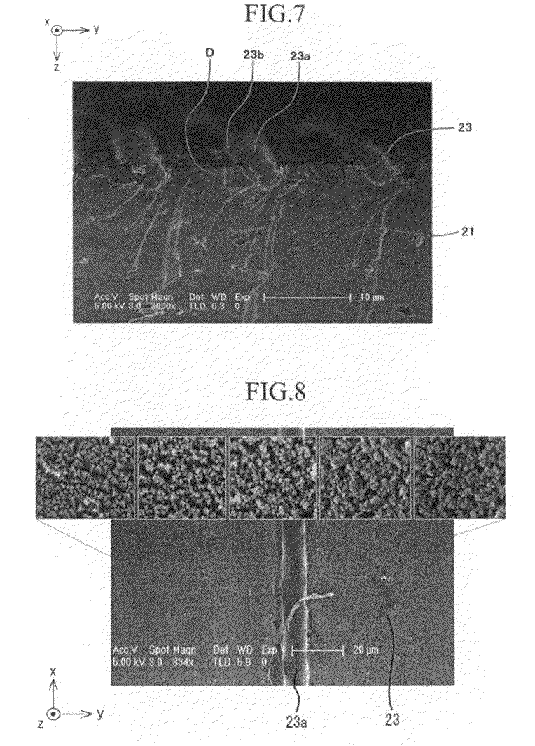

FIG. 6 illustrates an enlarged photograph of a top plan of the grooves 23a, and FIG. 7 illustrates a photograph of a cross-section of the groove 23a. Referring to FIGS. 6 and 7, the groove 23a may have a width W along the second direction, e.g., along the y-axis, and may have a depth D along the third direction, e.g., along the z-axis. As the width W and the depth D of the groove 23a increase, e.g., within a range that the groove 23a may be formed, the loss of the wall charges may be further reduced.

FIG. 8 illustrates a view of a structure change of the protective layer 23 around the groove 23a. Referring to FIG. 8, a structure of the protective later 23, e.g., a MgO layer, may be gradually changed as a distance along the second direction, e.g., along the y-axis, from the groove 23a increases. In other words, when the groove 23a is formed by laser machining, structure and shape of the protective layer 23 may change.

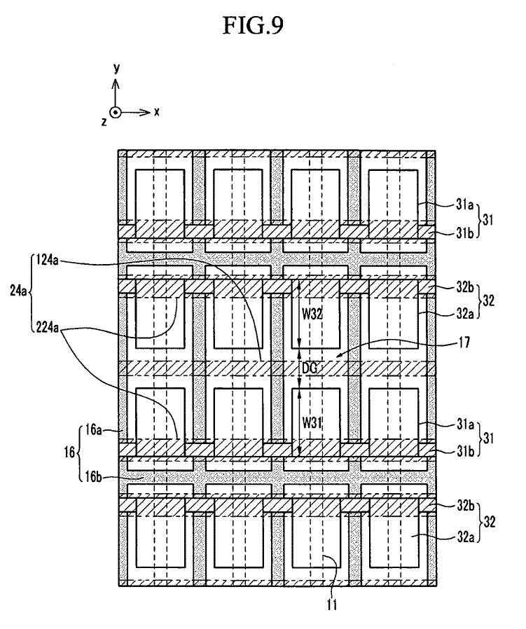

FIG. 9 illustrates a top plan view of an arrangement of discharge cells, electrodes, and grooves according to another exemplary embodiment. Referring to FIG. 9, a PDP may be substantially the same as the PDP described previously with reference to FIGS. 1-8, with the exception of including grooves 24a having a different configuration than grooves 23a.

Referring to FIG. 9, the grooves 24a may include a first groove 124a corresponding to centers of the discharge cells 17, i.e., substantially the same as grooves 23a described previously with reference to FIGS. 1-8, and a second groove 224a. The second grooves 224a may correspond to at least one of bus electrodes 31b and 32b extending in the x-axis direction, e.g., the second grooves 224a may overlap at least one of bus electrodes 31b and 32b. The second grooves 224a may be parallel to the first grooves 124a. Therefore, if one bus electrode 31b of the first electrode 31 and one bus electrode 32b of the second electrode 32 correspond to each discharge cell 17, two second grooves 224a corresponding to the bus electrodes 31a and 31b, respectively, may be positioned in each discharge cell 17, as illustrated in FIG. 9.

Thus, the first groove 124a may define two spaces in each discharge cell 17 adjacent in the y-axis direction, as discussed previously with reference to grooves 23a, to prevent or substantially minimize loss of the wall charges within the discharge cell 17 in the y-axis direction. In addition, the second grooves 224a may be positioned along edges of the discharge cells 17, i.e., to correspond to the bus electrodes, thereby corresponding to boundaries of each discharge cell 17 along the x-axis and preventing or substantially minimizing further loss of the wall charges in the y-axis direction. When the pair of the second grooves 224a corresponds to each discharge cell 17, surface conductivity of the protective layer 23 between discharge cells 17 adjacent along the y-axis may be reduced due to the second grooves 24a, so the loss of the wall charges may be prevented at both ends of each discharge cell 17 in the y-axis direction.

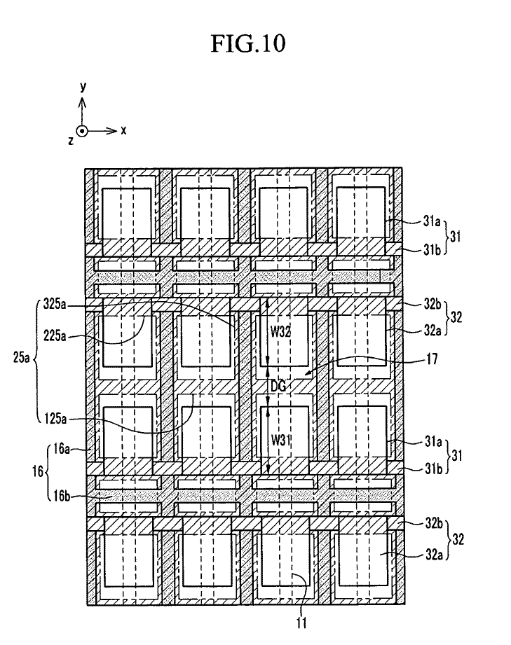

FIG. 10 illustrates a top plan view of an arrangement of discharge cells, electrodes, and grooves according to another exemplary embodiment. Referring to FIG. 10, a PDP may be substantially the same as the PDP described previously with reference to FIG. 9, with the exception of including grooves 25a having a different configuration than grooves 24a.

Referring to FIG. 10, the grooves 25a may include a first groove 125a corresponding to centers of the discharge cells 17 and second grooves 225a corresponding to the edge portions of the discharge cells 17, as described previously with reference to first and second grooves 124a and 224a of FIG. 9. In addition, the grooves 25a may further include third grooves 325a corresponding to first barrier rib members 16a, e.g., overlapping the first barrier rib members 16a, and extending in the y-axis direction, i.e., perpendicularly to the first and second grooves 125a and 125b.

Thus, since the first groove 225a may define two spaces in each discharge cell 17 adjacent in the y-axis direction, the loss of the wall charges in the y-axis direction, e.g., within the discharge cell 17, may be prevented or substantially minimized. Further, since the second grooves 255a may correspond to boundaries of each discharge cell 17 along the x-axis direction, the loss of the wall charges in the y-axis direction, e.g., between discharge cells 17 adjacent along the y-axis, may be further prevented or minimized. In addition, since the third grooves 325a may define boundaries of each discharge cell 17 along the y-axis direction, the loss of the wall charges in the x-axis direction, e.g., between discharge cell 17 adjacent along the x-axis, may be prevented or minimized as well.

A PDP according to exemplary embodiments may include a doped protective layer with at least one groove therein. The groove may be formed by a laser machining to face the discharge cells, so the groove may intercept a path where the wall charges may be lost, i.e., a conductive surface. Therefore, the doped protective layer may have a high secondary electron emission coefficient by doped impurities, and may exhibit low surface conductivity due to the structure and position of the groove. Accordingly, the loss of the wall charges may decrease at the protective layer, and thus, the operation margin may be increased when the PDP is driven.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
first and second substrates facing each other and spaced apart from each other;
barrier ribs arranged between the first and second substrates to define discharge cells;
phosphor layers in the discharge cells;
address electrodes extending on the first substrate along a first direction to correspond to the discharge cells;
first and second electrodes extending on the second substrate along a second direction to correspond to the discharge cells, the second direction crossing the first direction;
a dielectric layer on the first and second electrodes; and
a doped protective layer on the dielectric layer, the doped protective layer including at least one groove.

2. The PDP as claimed in claim 1, wherein the doped protective layer includes a dopanat, the dopant being one or more of Si, Al, Be, Cr, V, Sr, Ca, Li, F, Fe, Zr, Ni, and Sc.

3. The PDP as claimed in claim 1, wherein the at least one groove extends through an entire thickness of the protective layer and into a portion of the dielectric layer.

4. The PDP as claimed in claim 1, wherein the doped protective layer further comprises a residue portion around the at least one groove.

5. The PDP as claimed in claim 4, wherein the doped protective layer includes doped MgO, and the residue portion includes doped MgO and a dielectric material of the dielectric layer.

6. The PDP as claimed in claim 4, wherein the residue portion has non uniform height and uneven surface, the height and surface being determined with respect to a substantially flat interface between the doped protective layer and the dielectric layer.

7. The PDP as claimed in claim 1, wherein the at least one groove includes at least one first groove extending in the second direction and crossing centers of the discharge cells.

8. The PDP as claimed in claim 7, wherein each of the first electrodes and the second electrodes comprises:
at least one bus electrode extending in the second direction at edge portions of the discharge cells; and
at least one transparent electrode extending from the bus electrode toward centers of the discharge cells,
wherein the at least one groove includes at least one second groove corresponding to at least one of the bus electrodes of the discharge cells and parallel to the first groove.

9. The PDP as claimed in claim 8, wherein one bus electrode of the first electrode and one bus electrode of the second electrode correspond to each discharge cell, and a pair of second grooves corresponds to the bus electrodes of the first and second electrodes in each discharge cell.

10. The PDP as claimed in claim 8, wherein the barrier ribs include:
first barrier rib members extending in the first direction; and
second barrier rib members extending in the second direction to cross the first barrier rib members,
wherein the at least one groove includes at least one third groove extending in the first direction and corresponding to the first barrier rib members.

11. The PDP as claimed in claim 1, wherein the at least one groove defines two spaces in each discharge cell, the two spaces being adjacent to each other in the first direction.

12. The PDP as claimed in claim 1, wherein the at least one groove defines two spaces in each discharge cell, the two spaces being adjacent to each other in the first direction, and the at least one groove flurther defining boundaries of each discharge cell along the second direction.

13. The PDP as claimed in claim 1, wherein the at least one groove defines two spaces in each discharge cell, the two spaces being adjacent to each other in the first direction, and the at least one groove further defining boundaries of each discharge cell along the first direction and the second direction.

14. The PDP as claimed in claim 1, wherein the PDP includes a plurality of grooves facing the discharge cells, each groove extending along the second direction to overlap a plurality of discharge cells, at least one groove corresponding to each discharge cell.

15. A method of forming a plasma display panel (PDP), comprising:
forming first and second substrates facing each other and spaced apart from each other;
forming barrier ribs between the first and second substrates to define discharge cells;
forming phosphor layers in the discharge cells;
forming address electrodes extending on the first substrate along a first direction to correspond to the discharge cells;
forming first and second electrodes extending on the second substrate along a second direction to correspond to the discharge cells, the second direction crossing the first direction;
forming a dielectric layer on the first and second electrodes; and
forming a doped protective layer on the dielectric layer, the doped protective layer including at least one groove.

16. The method as claimed in claim 15, wherein forming the doped protective layer includes laser machining the at least one groove in the doped protective layer.
